(19) United States
(12) Patent Application Publication
(10) Pub. No.: US 2025/0308369 A1
(43) Pub. Date: Oct. 2, 2025

(54) Electronic Device Case with Removable Components and Locator and Luggage or Body Including Same

(71) Applicant: Li Zhijian, Fuzhou (CN)

(72) Inventor: Li Zhijian, Fuzhou (CN)

(21) Appl. No.: 19/234,167

(22) Filed: Jun. 10, 2025

Related U.S. Application Data
(63) Continuation-in-part of application No. 19/183,860, filed on Apr. 19, 2025.
Application No. 19/183,860 is a continuation-in-part of application No. 18/243,126, filed on Sep. 7, 2023.
Application No. 18/243,126 is a continuation-in-part of application No. 17/884,336, filed on Aug. 9, 2022, now Pat. No. 11,789,125.
Application No. 17/884,336 is a continuation of application No. 17/573,677, filed on Jan. 12, 2022, now Pat. No. 11,573,291.
Application No. 17/573,677 is a continuation of application No. 17/510,438, filed on Oct. 26, 2021, now Pat. No. 11,475,756.
(60) Provisional application No. 63/636,702, filed on Apr. 19, 2024.
(60) Provisional application No. 63/658,150, filed on Jun. 10, 2024.

(30) Foreign Application Priority Data
Sep. 10, 2021 (CN) 202111063066.1
Jun. 23, 2022 (CN) 202221606848.5

(51) Int. Cl. G08B 21/24; G01S 7/481; G01S 17/46; G08B 3/10

(52) U.S. Cl. CPC G08B 21/24; G01S 7/4813; G01S 17/46; G08B 3/1083

(57) ABSTRACT

A piece of luggage comprising a device including a primary circuit board in a base case that can provides near field communication (NFC) functionality or other primary functionality, wherein the device further includes a selectively installable and removable secondary circuit board that provides the device with secondary functionality that is different from the primary functionality including at least one of lighting, position locating, GPS, sound, video or image capture, RFID, wherein the secondary circuit board includes a secondary connector that mates with a primary connector of the primary circuit board when the secondary circuit board is installed. The base case includes a recess that receives the secondary circuit board, and the primary connector is located in the recess. A battery can be installed in the recess with the secondary circuit board. In some embodiments, a battery and circuit board are individually connected and disconnected from the base case.

### CROSS-REFERENCE TO RELATED APPLICATIONS

This application is a continuation-in-part of U.S. application Ser. No. 19/183,860 filed Apr. 19, 2025, which is a continuation-in-part of U.S. application Ser. No. 18/243,126 filed Sep. 7, 2023, which is a continuation-in-part of U.S. Ser. No. 17/884,336 filed Aug. 9, 2022, now U.S. Pat. No. 11,789,125 issued Oct. 17, 2023, which is a continuation of U.S. Ser. No. 17/573,677 filed Jan. 12, 2022, now U.S. Pat. No. 11,573,291 issued Feb. 7, 2023, which is a continuation of U.S. Ser. No. 17/510,438 filed Oct. 26, 2021, now U.S. Pat. No. 11,475,756 issued Oct. 18, 2022, and the entire disclosure of each of said prior applications is hereby expressly incorporated by reference into the present specification. U.S. application Ser. No. 19/183,860 filed Apr. 19, 2025 also claims priority from and benefit of the filing date of U.S. provisional application Ser. No. 63/636,702 filed Apr. 19, 2024, and the entire disclosure of said provisional application is hereby expressly incorporated by reference into the present specification. This application also claims priority from and benefit of the filing date of U.S. provisional application Ser. No. 63/658,150 filed Jun. 10, 2024, and the entire disclosure of said provisional application is hereby expressly incorporated by reference into the present specification. This application also claims priority from Chinese application no. 202221606848.5 filed Jun. 23, 2022 and Chinese application no. 202111063066.1 filed Sep. 10, 2021, and the entire disclosure of each of said prior Chinese applications is hereby expressly incorporated by reference into the present specification.

### BACKGROUND

Devices that include Near Field Communication (NFC) capabilities and/or position locating capabilities are generally known. Such known devices have been found to be deficient with respect to their ease of use and ability to be customized by the end-user to provide the functions desired by a user. As such, a need has been identified for a new and improved device that can be customized by a user to have the desired functions.

Additionally, with the advent of the artificial intelligence (Al) era, a locator device will be widely used to locate luggage, golf clubs, wearable devices for people, and/or other items. Currently, locator functionality is only a “locate and find” function, i.e., where is the item.

### SUMMARY

According to one example, the present development relates to a luggage or other product that includes a device that provides Near Field Communication (NFC) capabilities, wherein the device includes a selectively installable and removable secondary circuit board that provides the device with secondary functionality such as lighting, position locating, GPS, sound, video or image capture, RFID, and/or other secondary functionality. The device can also include a selectively installable and removable battery.

According to another embodiment of the present development, a main body includes a base case, wherein the base case implanted with an NFC chip which can be used to authenticate goods of the main body. The NFC chip is implanted and fixed to the base case provided in the main body. The base case further includes a circuit board interface and a removable battery. The main body also includes a removable secondary circuit board that is selectively connected to and removable from the circuit board interface on the base case. The removable battery is configured to provide electrical power to the secondary circuit board.

According to another alternative embodiment of the present development, a body (which may be a bag, an electronic product, or other product) contains a main circuit board, and further includes a secondary circuit board that may be plugged in at will on demand to the main circuit board to provide secondary functionality which may be IoT functionality.

According to another embodiment of the present development, a circuit board for a locator device includes a base, and a main printed circuit board assembly (PCBA) separate from the base.

According to another embodiment of the present development, a circuit board for a locator device includes a base, a main PCBA separate from the base, and a battery charging circuit separate from the base and main PCBA.

According to another embodiment of the present development, a piece of luggage includes a circuit board for a locator device that includes a base, a main printed circuit board assembly (PCBA) separate from the base, and a battery charging circuit separate from the base and main PCBA.

### BRIEF DESCRIPTION OF THE DRAWINGS

FIG. 1 (including FIGS. 1A, 1B, 1C, 1D) shows multiple different views of a device case or a base case according to an embodiment of the present development including a primary printed circuit board including a near field communication (NFC) chip embedded inside the device case/base case.

FIG. 2 (including FIGS. 2A, 2B, 2C, 2D) includes additional views of the base case of FIG. 1 showing an assembly sequence.

FIG. 3 (including FIG. 3A & 3B) shows an alternative base case structure.

FIG. 4 shows that the base case can be operatively connected to a device or body such as a fanny pack or other luggage such as a backpack, briefcase, purse, sports bag, tote bag, phone case, or other body/device.

FIG. 5 shows another embodiment in which the secondary circuit board is configured as a locator or other device and includes a projecting secondary connector that be plugged into or otherwise operatively mated with a slot or other primary or receiver connector of a housing of the base case.

FIG. 6 shows that the base case can be installed or otherwise connected to a backpack.

FIG. 7 is an exploded view that shows another alternative embodiment in which the battery can be selectively installed in or removed from a battery slot located in the base case housing.

FIG. 8 shows the device of FIG. 7 fully operatively assembled.

FIGS. 9-12 provide multiple views of differently shaped and configured removable secondary circuit boards each with a secondary connector.

FIG. 13A provides a fully assembled view and an exploded view of the secondary circuit board of FIG. 12 operatively installed in a recess of the housing.

FIG. 13B is similar to FIG. 13A but provides a fully assembled view and an exploded view of the secondary circuit board of FIG. 12 operatively installed in a recess of an alternative housing.

FIG. 14 provides multiple views of a disc shaped removable secondary circuit board with a connector to be selectively and releasably installed in a housing.

FIG. 15A shows a base case including the disc shaped secondary circuit board of FIG. 14 operatively installed.

FIG. 15B is an exploded view corresponding to FIG. 15A.

FIGS. 15C & 15D are respectively similar to FIGS. 15A & 15B, but the battery is contained inside the housing and/or on the secondary circuit board.

FIG. 16A shows a base case including a removable secondary circuit board of FIG. 12 operatively installed.

FIG. 16B is an exploded view corresponding to FIG. 16A.

FIGS. 16C & 16D are respectively similar to FIGS. 16A & 16B, but the battery is contained inside the housing and/or on the removable secondary circuit board.

FIG. 17A shows a base case B including the removable secondary circuit board of FIG. 12 operatively installed.

FIG. 17B is an exploded view corresponding to FIG. 17A.

FIG. 18 (including FIGS. 18A, 18B, 18C, 18D) shows another example of a base case B and its components as described above.

FIG. 19 (including FIGS. 19A, 19B, 19C, 19D) shows that the base case can include a power on/or button for selectively activating the electronic function of the secondary circuit board and/or for selectively activating the and/or other electronic circuitry installed in the housing on the primary circuit board.

FIG. 20 shows an embodiment of the present development comprising a device including a base and a main function module that can be selectively operably connected and disconnected.

FIG. 21 shows that the base and removable main function module (when connected forming a device) of FIG. 20 can be installed or otherwise connected to a backpack or any other item of luggage or any other item.

FIG. 22 shows the device including the base and a removable main function module connected to the base of FIG. 19 can also be provided as part of a wearable device.

FIG. 23 (including FIGS. 23A-23F) shows additional examples of devices that include the base and removable main function module of FIG. 20.

FIG. 24 (including FIGS. 24A-F) shows different configurations of the main function module of FIG. 20.

FIG. 24G shows one example configuration of the main function module of FIG. 24.

FIGS. 25A and 25B show an embodiment of the device of FIG. 20 showing the connection and disconnection of the base and the main function module.

FIG. 26 shows a schematic view of the device of FIG. 20.

FIG. 27 shows another schematic view of the device of FIG. 20.

FIG. 28 shows another schematic view of the device of FIG. 20.

FIG. 29 shows another schematic view of the device of FIG. 20.

FIG. 30 shows another schematic view of the device of FIG. 20.

### DETAILED DESCRIPTION

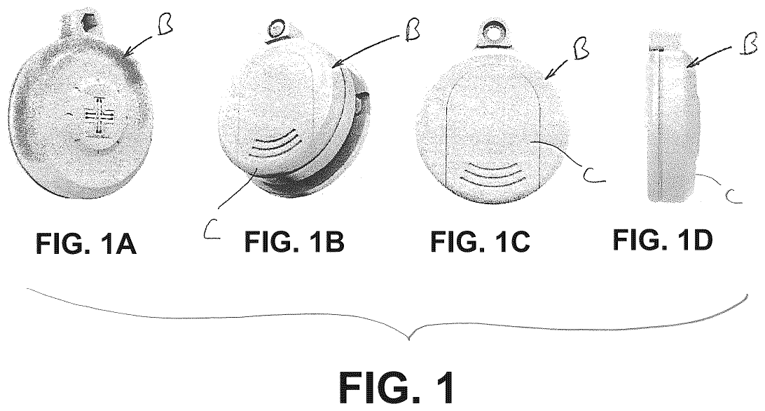

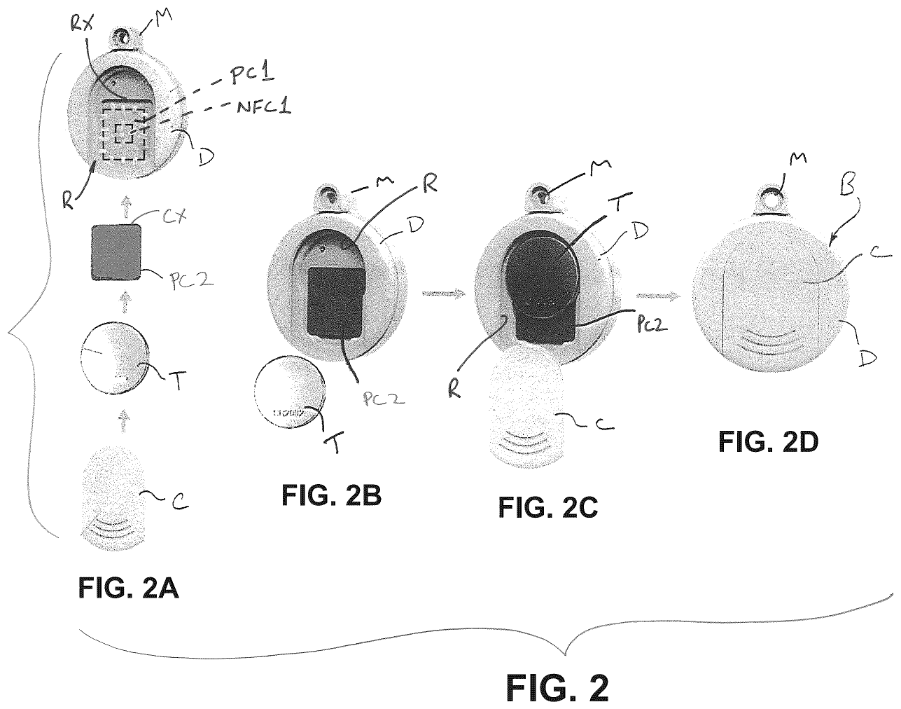

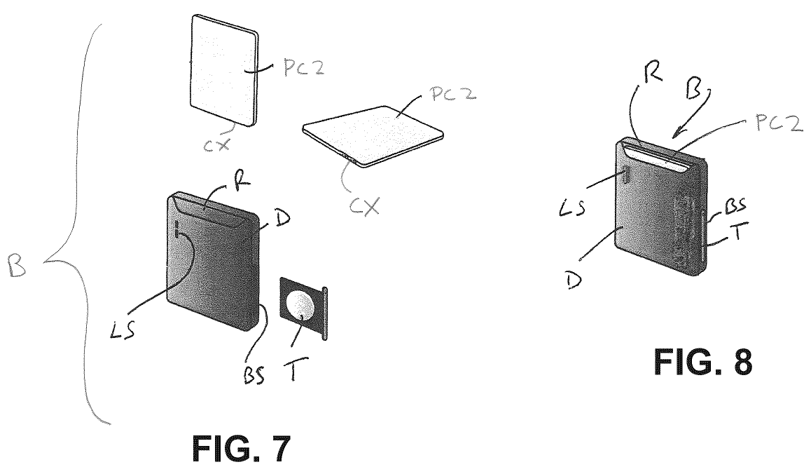

FIG. 1 (including FIGS. 1A, 1B, 1C, 1D) shows multiple different views of a device case or a base case B including a primary printed circuit board PC1 including a near field communication (NFC) chip NFC1 embedded inside the device case/base case B. As shown in FIG. 2 (including FIGS. 2A, 2B, 2C, 2D), the base case B includes a housing D in which the NFC chip NFC1 is embedded on the primary circuit board PC1 for providing a primary functionality of near field communication. The housing D includes a recess or other circuit board receiving location R that can be configured to receive and retain a removable secondary printed circuit board PC2 and that can also be configured to receive a battery or battery pack T, which can be rechargeable by a wired or wireless charger, to provide electrical power to the secondary printed circuit board PC2. In particular, the recess R includes a receiver or primary connector RX that is operably electrically connected to the primary circuit board PC1 and that is configured to be operably mated with a secondary circuit board connector CX (secondary connector CX) of the secondary circuit board PC2 that is operably connected to the electronic components of the secondary circuit board PC2. In particular, the secondary printed circuit board PC2 includes one or more electronic devices that can be configured to perform a wide variety of different auxiliary or secondary functions or secondary functionality that is different from the primary functionality of the primary circuit board PC1. The secondary functionality can include at least one of lighting, device location, GPS, sound output, video/camera image capturing, speaker, radio frequency access control/security, and/or any other desired secondary electronic functions. A cover C portion of the housing D (which is optional as described below in relation to FIGS. 7 & 8) can be selectively removed from a main portion of the housing D that includes the primary circuit board PC1 or is otherwise movable relative to the main portion of the housing D to open the recess R for installation and/or removal or replacement of the secondary circuit board PC2 and/or battery T. The cover C can also be selectively connected to the main portion of the housing D to close the recess R and capture the secondary circuit board PC2 and battery T in their respective installed operative positions inside the recess R. In the illustrated example, the battery T is located between the cover C and the secondary circuit board PC2 and the cover C presses the battery T into contact with the secondary circuit board to maintain the battery T in its operative position so that the battery T is electrical connected to electrical contacts of the secondary circuit board PC2 so that the battery T can supply electrical power to the electronic devices of the secondary circuit board PC2. The housing D can also include a mounting tab M or other location for receiving a fastener, stitching, a mounting ring, a post/stud, and/or any other suitable fastening device for operatively securing the base case B (housing D) to a support structure or body such as a piece of luggage, another device, a person's clothing or portable device (e.g., mobile telephone or other device), a golf or other sports bag or equipment, and/or any other support structure. The primary circuit board PC1 is shown in the present example as including a near field communication circuit NFC1 that provides the primary functionality as near field communication, but the primary circuit board PC1 can include electronic circuitry that provides alternative primary functionality such as at least one of lighting, device location, GPS, sound output, video/camera image capturing, speaker, radio frequency access control/security, and/or any other desired electronic function. As noted above, the secondary functionality provide by the secondary circuit board PC2 is different than the primary functionality provided by the primary circuit board PC1.

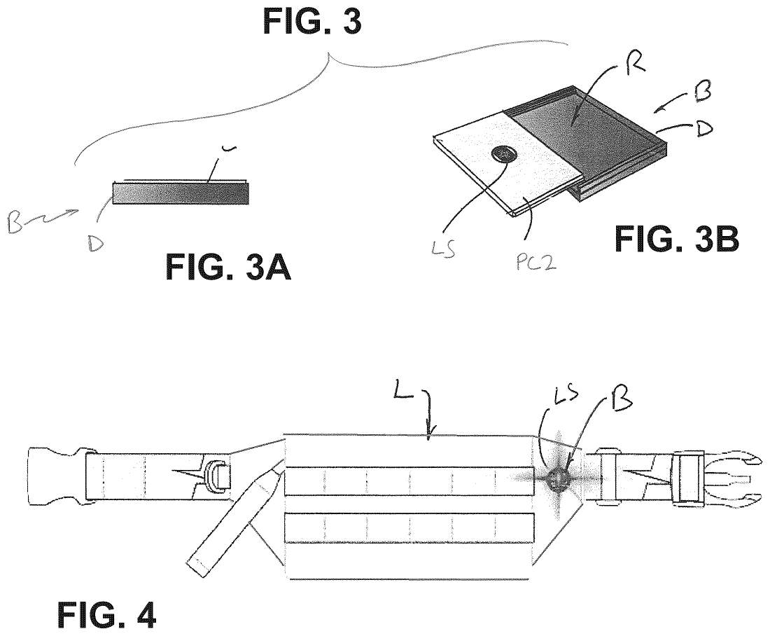

As shown in FIG. 3, the base case can be any desired shape such as circular/disc shaped (FIGS. 1 & 2) or rectangular/square FIG. 3.

FIG. 4 shows that the base case B including the secondary circuit board PC2 and battery T and cover C can be operatively connected to a device or body such as a fanny pack or other luggage L such as a backpack, briefcase, purse, sports bag, tote bag, phone case, or other body/device. The base case B can include one or more LEDs or other light source(s) LS that can be continuously or selectively illuminated or partially illuminated under only certain conditions such as full battery charged, partial battery charge, low battery charge, or in response to a voice command, detection of a known or unknown mobile phone or other device, or any other condition.

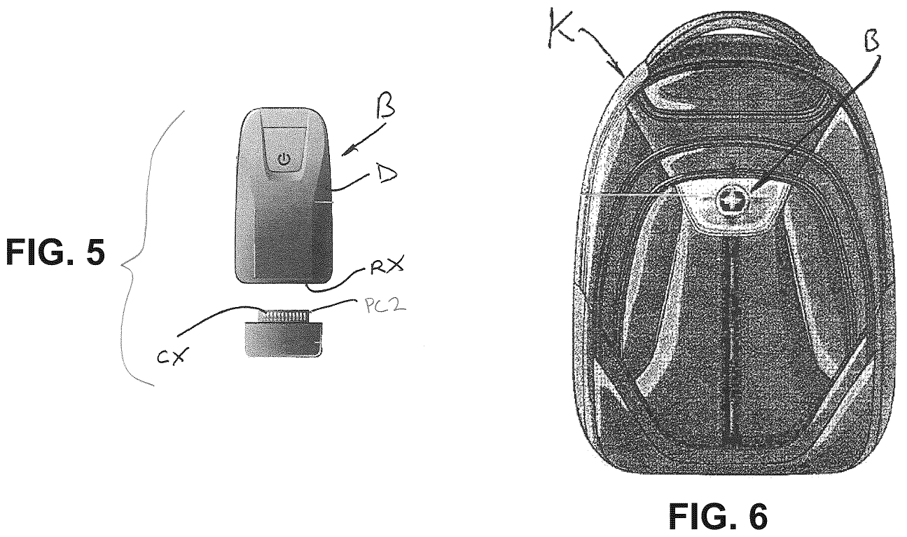

FIG. 5 shows another embodiment in which the secondary circuit board PC2 is configured as a locator or other device and includes a projecting secondary connector CX that be plugged into or otherwise operatively mated with a slot or other primary or receiver connector RX the housing D of the base case B so that the secondary circuit board PC2 can be operatively electrically connected to the primary circuit board PC1 inside the base case B which includes an NFC chip, battery, and/or any other circuit or electronic device located in the housing D. The mated primary and secondary connectors CX/RX provide an operative electrical connection between the primary circuit board PC1 located in the base case B and the secondary circuit board PC2 operably connected to the base case B. In this example, the battery T can be located within the base case body D, or the secondary circuit board PC2 including position locator circuitry can be provided as part of a circuit board housing PX that includes a battery T that can be rechargeable (e.g., wirelessly and/or through the secondary connector CX and/or be a replaceable battery). In this embodiment, the secondary circuit board PC2 is shown as a locator circuit board that can use any suitable wireless device location technology known in the art such as GPS, Bluetooth location, internet of things IoT, and/or any suitable radio frequency location technology.

FIG. 6 shows that the base case B can be installed or otherwise connected to a backpack K.

FIG. 7 is an exploded view that shows another alternative embodiment in which the battery T can be selectively installed in or removed from a battery slot BS located in the base case housing D that can be separate from the circuit board recess R. In this embodiment, the recess R is configured to slidably or otherwise receive and retain the secondary circuit board PC2 without use of a cover C. The secondary circuit board PC2 can be configured with the required electronic circuitry to function as a device locator circuit board or another function (sound input/output, video/image input output, communication, radio frequency access control for security, or any other secondary function. As shown, the secondary circuit board PC2 can include a secondary connector CX to mate with a mating receiver connector or primary RX located inside the recess R for operative electrical connection of the secondary circuit board PC2 with the primary circuit board PC1 inside the base case housing D.

FIG. 8 shows the device of FIG. 7 fully operatively assembled.

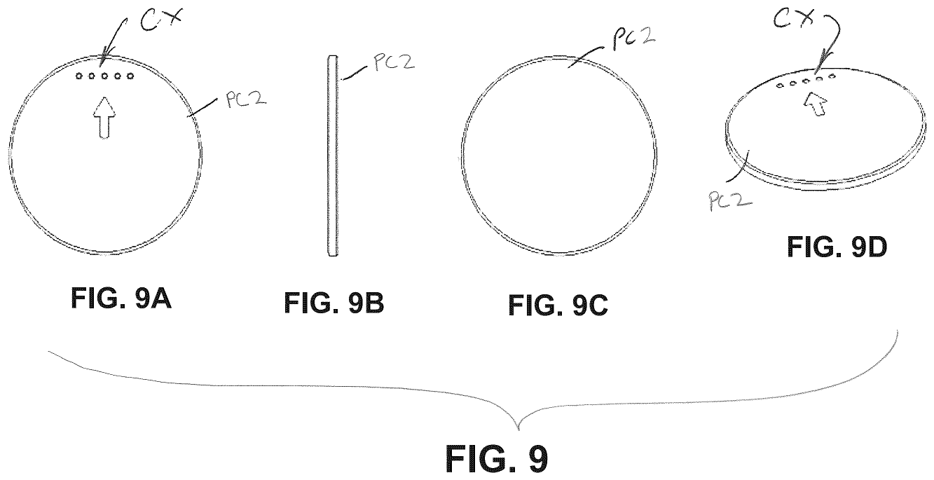

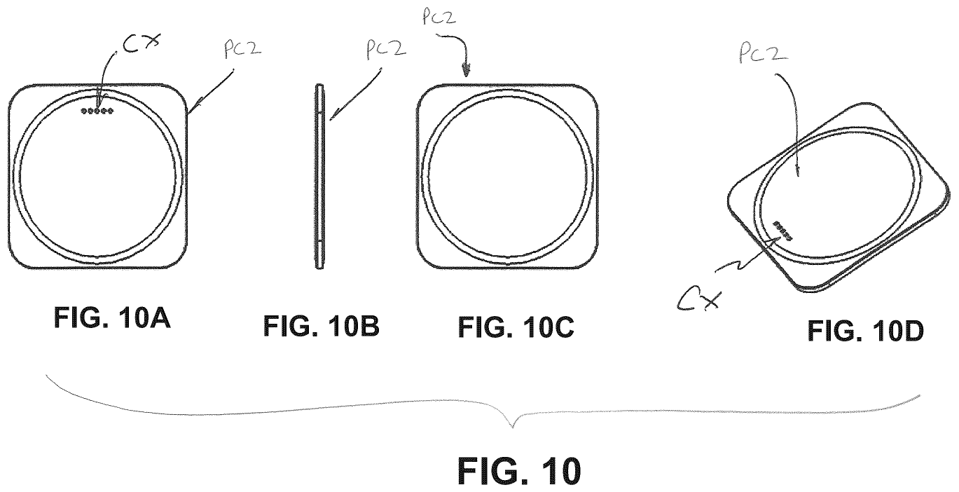

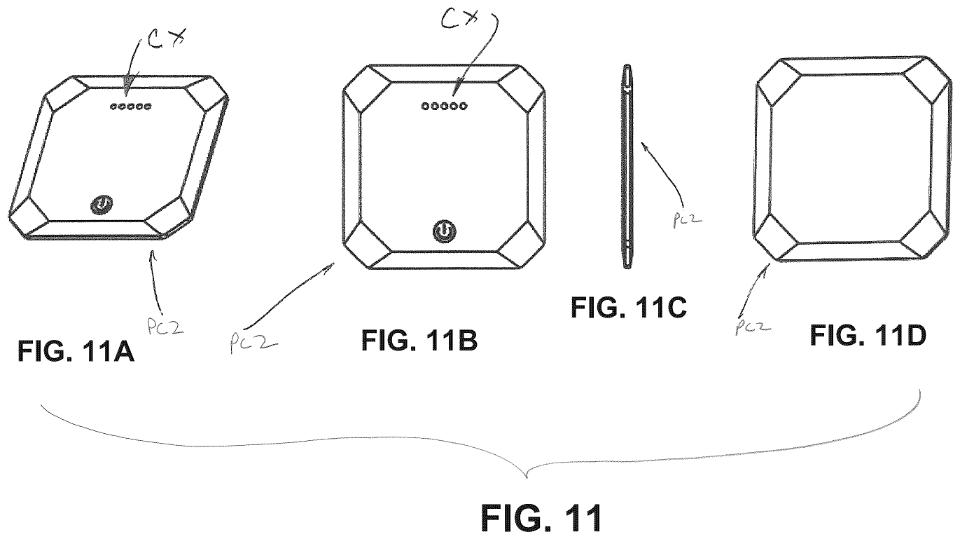

FIGS. 9-12 provide multiple views of differently shaped and configured removable secondary circuit boards PC2 with a secondary connector CX to be selectively and releasably installed in a housing D to mate with the receiving connector RX of the primary circuit board PC1 to form a complete base case B.

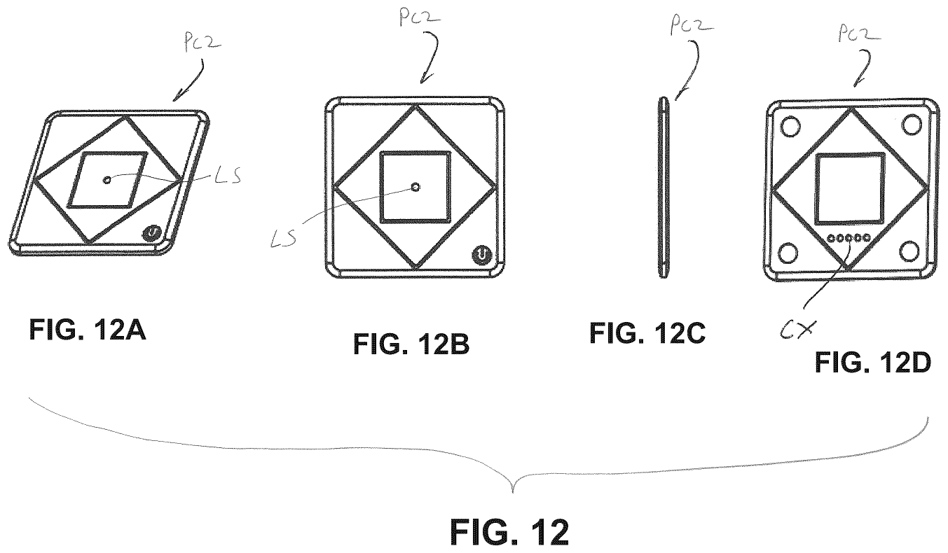

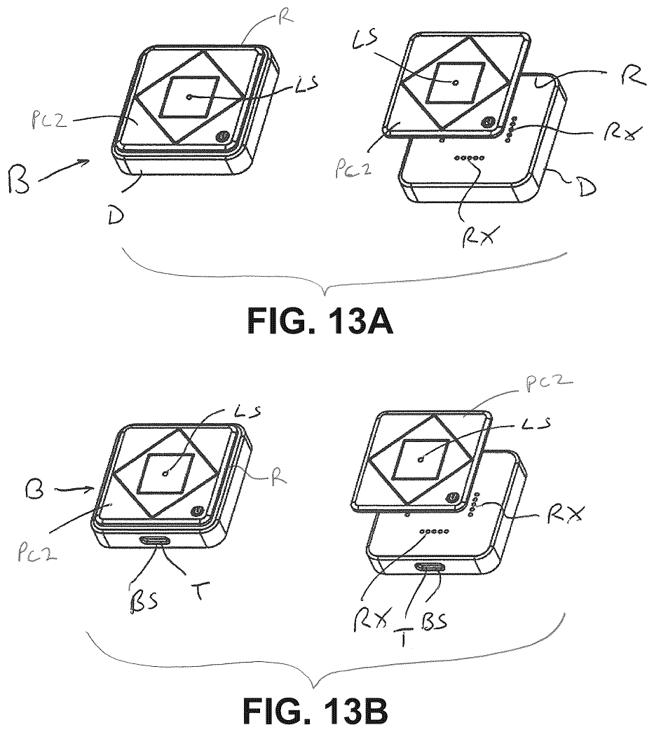

FIG. 13A shows the secondary circuit board PC2 of FIG. 12 operatively installed in a recess R of a base D (the battery T can be part of the secondary circuit board PC2 and/or can be located inside the housing D.

FIG. 13B is similar to FIG. 13A but shows the secondary circuit board PC2 of FIG. 12 operatively installed in a recess R of a base D (the battery T can be part of the secondary circuit board PC2 and/or can be located inside the housing D). An external slot BS can be provided to selectively receive and retain a battery T that provides electrical power to the secondary circuit board PC2 (and optionally also provides electrical power to the primary circuit board PC1). The external slot BS can alternatively be configured as an external power/data connector slot BS and include a power/data connector such as a USB Type-C or other USB or other connector for mating with a corresponding connector of a cable to charge a battery inside the housing D or the battery inside the housing and/or provide data transfer to the primary or secondary circuit boards PC1,PC2. can be wireless charged. In such case, the connector slot BS can be used to input or output data to/from the base case B using a cable connected with the slot BS.

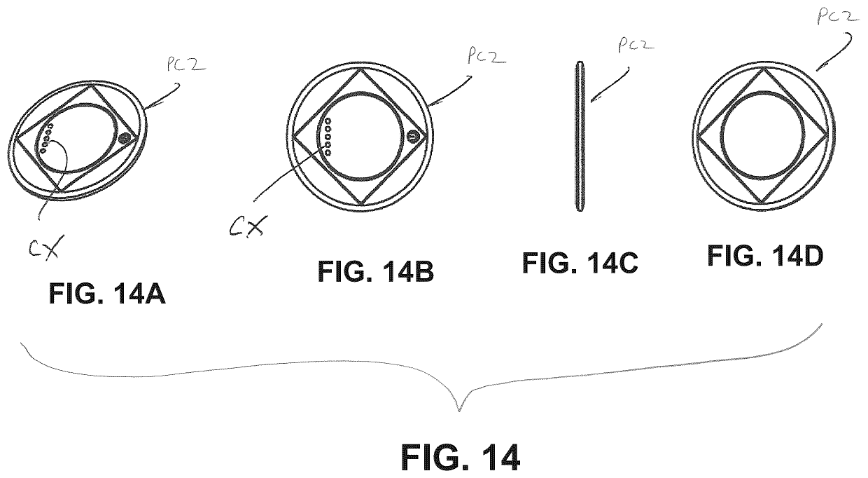

FIG. 14 provides multiple views of a disc shaped removable secondary circuit board PC2 with a connector CX to be selectively and releasably installed in a housing D and mated with a receiving connector RX of the primary circuit board PC1 to form a complete base case B.

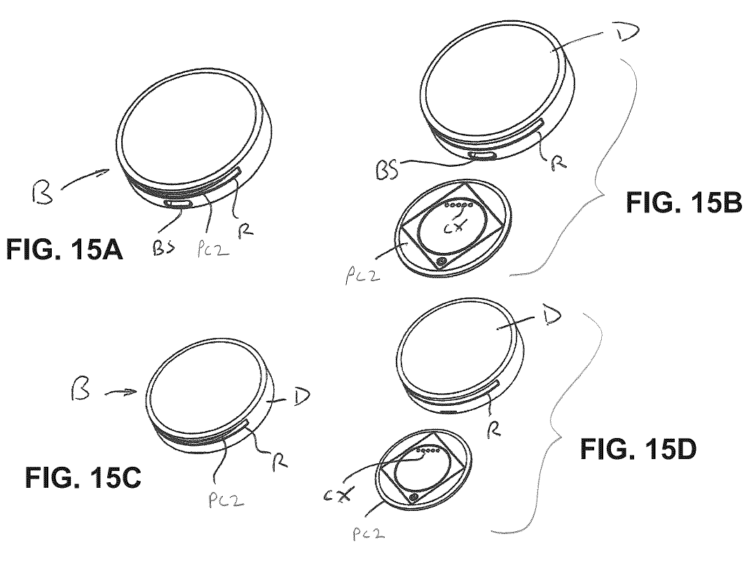

FIG. 15A shows a base case B including the secondary circuit board PC2 of FIG. 14 operatively installed (FIG. 15B is the corresponding exploded view). Again, as noted above, for this and all other embodiments, the slot BS defined in the housing D can receive a battery T or can be provided as a connector slot such as a USB connector slot to connect a power charging and/or data cable for providing power to and/or exchanging data with the base case B.

FIGS. 15C & 15D are respectively similar to FIGS. 15A & 15B, but the battery T is contained inside the housing D and/or on the secondary circuit board PC2.

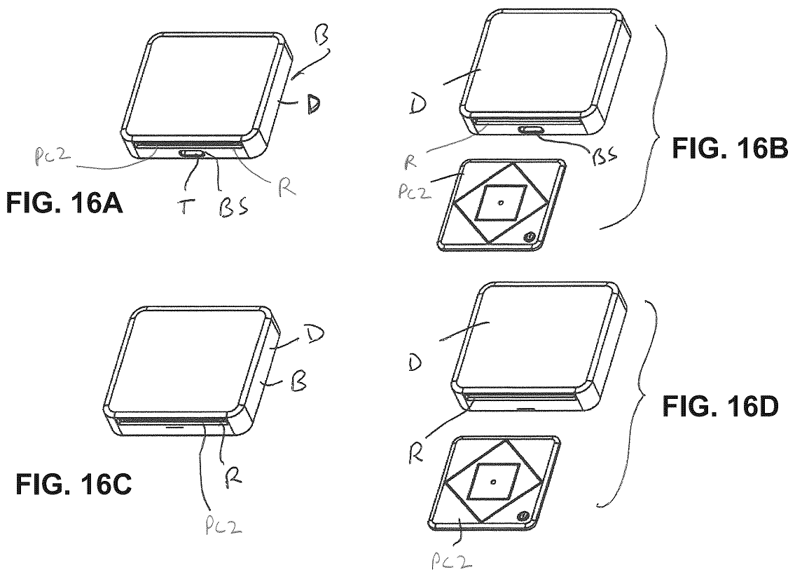

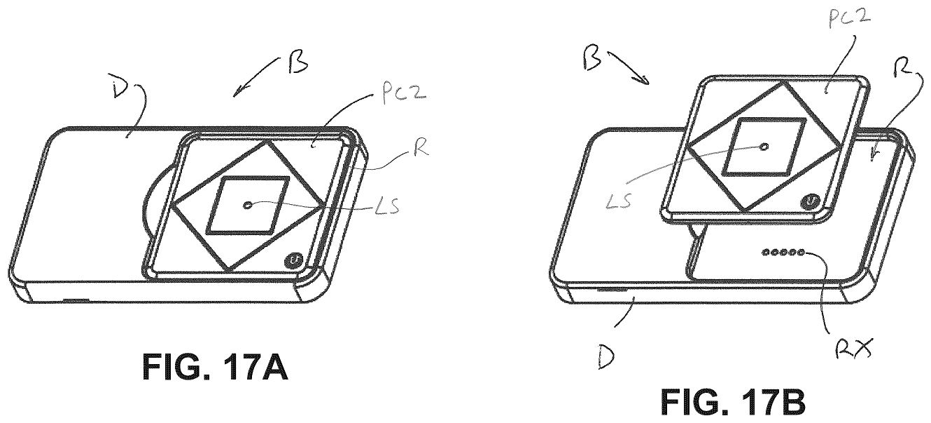

FIG. 16A shows a base case B including the removable secondary circuit board PC2 of FIG. 12 operatively installed (FIG. 16B is the corresponding exploded view). Again, as noted above, for this and all other embodiments, the slot BS of the housing can receive a battery T or can be provided as a connector slot such as a USB connector slot to connect a power charging and/or data cable for providing power to and/or exchanging data with the base case B.

FIGS. 16C & 16D are respectively similar to FIGS. 16A & 16B, but the battery T is contained inside the housing D and/or on the removable secondary circuit board PC2.

FIG. 17A shows a base case B including the removable secondary circuit board PC2 of FIG. 12 operatively installed (FIG. 17B is the corresponding exploded view). Again, as noted above, for this and all other embodiments, the housing D can include a slot to receive a battery T and/or the housing D can be provided with a connector slot such as a USB connector slot to connect a power charging and/or data cable for providing power to and/or exchanging data with the base case B. A battery T can be included in the housing and/or on the secondary circuit board PC2 and can be replaceable and/or rechargeable by a wired or wireless charger.

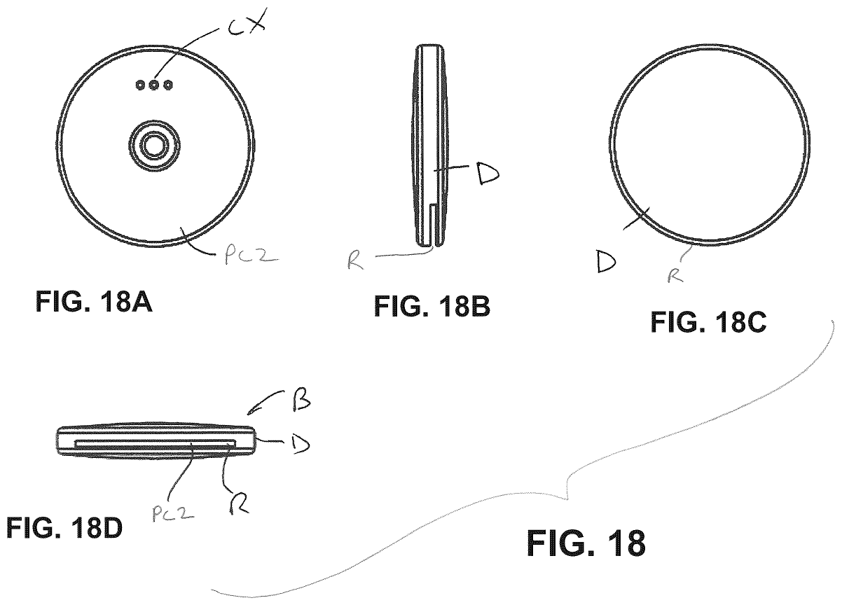

FIG. 18 shows another example of a base case B and its components as described above.

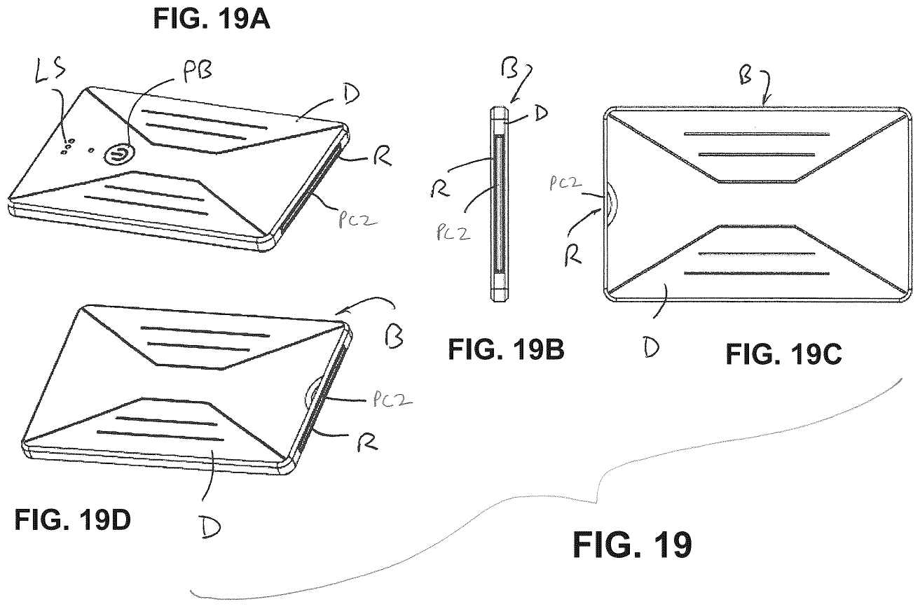

As shown in FIG. 19 and other views above, the base case B can include a power on/or button PB for selectively activating the electronic function of the secondary circuit board PC2 and/or for selectively activating the NFC and/or other electronic circuitry installed in the housing D on the primary circuit board PC1.

In some embodiments, in order to facilitate and reduce the cost and time of upgrading the functionality of an existing locator device, the primary printed circuit board PC1 and the secondary circuit board PC2 can be separately attachable and detachable to the base case B. The disclosed device can comprise a locator device (or another electronic device that is different from a locator device) including at least two separable components including: (i) the base case B; and (ii) main function module (module) M that includes an electronic printed circuit board assembly (PCBA) (i.e., the primary printed circuit board PC1) configured to perform a locator function or other function and that is selectively connected to the base case B and that can separated from the base case B and replaced with a new or different main function module (i.e., the secondary circuit board PC2) with enhanced and/or different functionality as compared to the previous main function module (i.e., the primary printed circuit board PC1) that was connected to the base case B. The base case B is relatively fixed and permanent, to provide a number of basic functions, including but not limited to the power supply function through the battery T or other power source included in the base case. The main function module includes a PCBA configured to perform a function and designed for the user (consumer) to connect the main function module PC1 to the base case B and remove the main function module PC1 from the base case B so that the main function module can receive electrical power from the power supply of the base case B and can optionally send and receive electronic data and electrical signals to and/or from the base case B. In this manner, the user can remove a first main function module (again, the primary printed circuit board PC1) from the base case B and replace the first main function module with a second main function module (again, the secondary circuit board PC2) that the user connects to the base case B, wherein the second main function module has enhanced and/or different functionality as compared to the first main function module (i.e., the PCBA of the second main function module is enhanced and/or different from the PCBA of the first main function module). In this manner, the base case B including the power supply can be re-used without being discarded or replaced when the functionality of the locator or other device is updated. Also, this disclosed arrangement eliminates the need to re-design the plastic housing and other parts of the locator device when the device is upgraded, which greatly reduces the development cycle of new products and the cycle to market. The disclosed locator will be widely used in a wide range of applications including wearable positioners (locators). The main function module of the locator can also be upgraded to include e-cigarette function and other functions, i.e., the main function module can include a PCBA and other components that are configured as an e-cigarette module that can be re-charged or otherwise activated and operated when connected to the base.

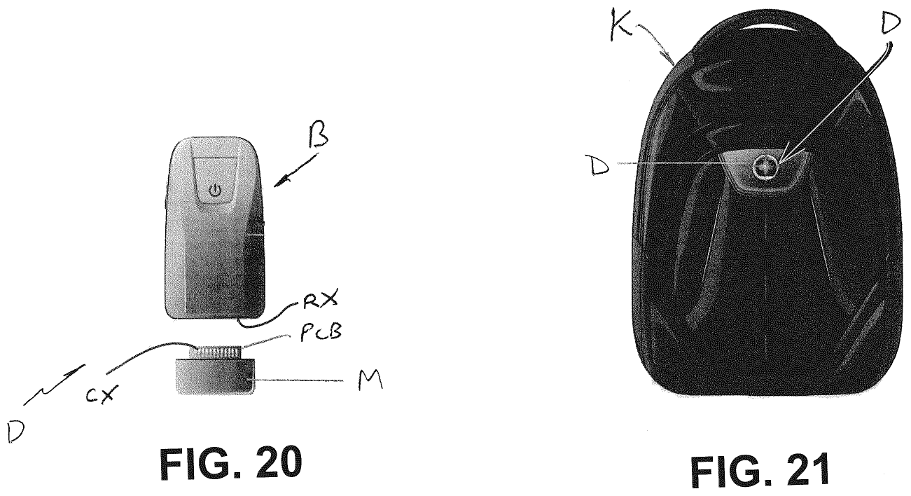

FIG. 20 hereof shows an embodiment of the present development comprising a device D including a base (or base case) B and a main function module (or main printed circuit board assembly) M that can be selectively operably connected to the base B by a user and that can be selectively disconnected from the base B by the user without any special tools, i.e., the user can simply manually plug or otherwise manually connect the main function module M into the base and the user can also manually pull or otherwise disconnect the main function module M from the base B. In the illustrated example, the main function module M includes a printed circuit board assembly PCBA configured as a locator device but the printed circuit board assembly PCBA can alternatively be configured to perform an e-cigarette function or any other desired function. The main function module M can include a connector CX that can be plugged into or otherwise operatively mated with a slot or other receiver connector RX of the base B so that the printed circuit board assembly PCBA can be operatively electrically connected to the battery or other power source and/or any other circuit or electronic device located in the base B mated connectors CX/RX. In this example, the base B includes a rechargeable battery that can be recharged using a wired or wireless charger device. In this embodiment, the circuit board PCB is shown as a locator circuit board that can use any suitable wireless device location technology known in the art such as GPS, Bluetooth location, internet of things IoT, and/or any suitable radio frequency location technology.

FIG. 21 shows that the base B and removable main function module M (when connected forming a device D) can be installed or otherwise connected to a backpack K or any other item of luggage or any other item.

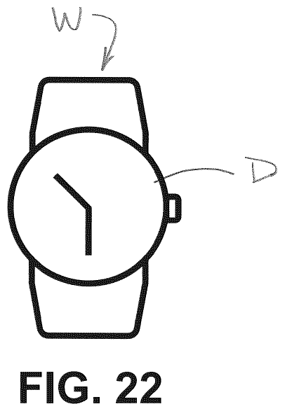

FIG. 22 shows the device D including the base B and a removable main function module M connected to the base B can also be provided as part of a wearable device W or item such as a watch, a belt, a shoe or the like to be worn by a person or a pet such as a dog or cat.

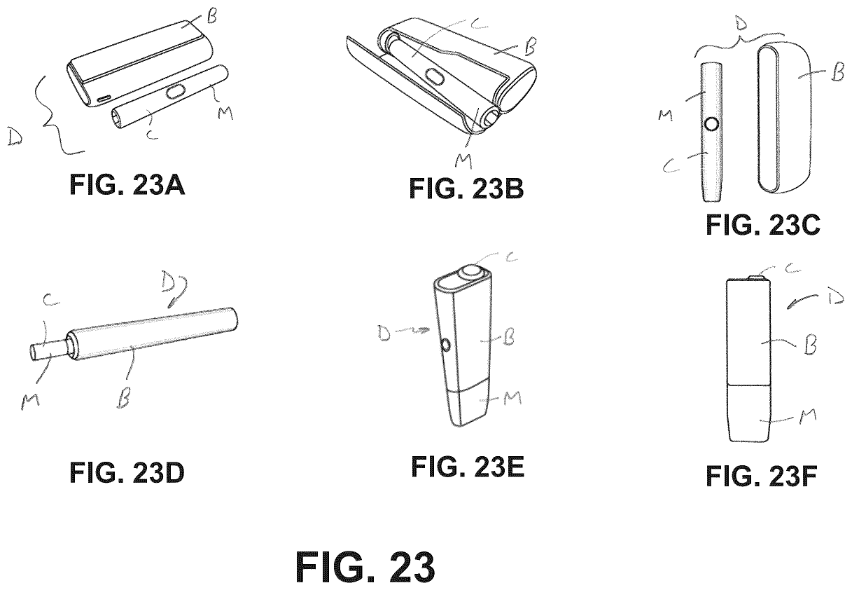

FIG. 23 (including FIGS. 23A-23F) shows additional examples of devices D that include the base B and removable main function module M. In the example of FIG. 23, the base B can be a holding & charging module base for an e-cigarette including a battery, and the removable main function board M (including a locator circuit device) can be included as part of and/or releasably connected to a vapor cigarette suction device C to be used as a vapor inhaler by a user and/or the removable main function board M (including the locator circuit device) can be separate from the cigarette suction device C but connected to the base B, i.e., the removable main function board M can be included as part of the cigarette suction device C that is releasably connected to the base (see FIGS. 23A,23B,23C,23D) and/or the removable main function board M can be separate from the cigarette suction device C and be releasable connected to the base B (see FIGS. 23E & 23F). In this manner, a user of the e-cigarette device D can easily track the location of the e-cigarette device D (the base B and/or the suction component C depending upon the location of the removable main function board as being in the base B, the suction device C or both).

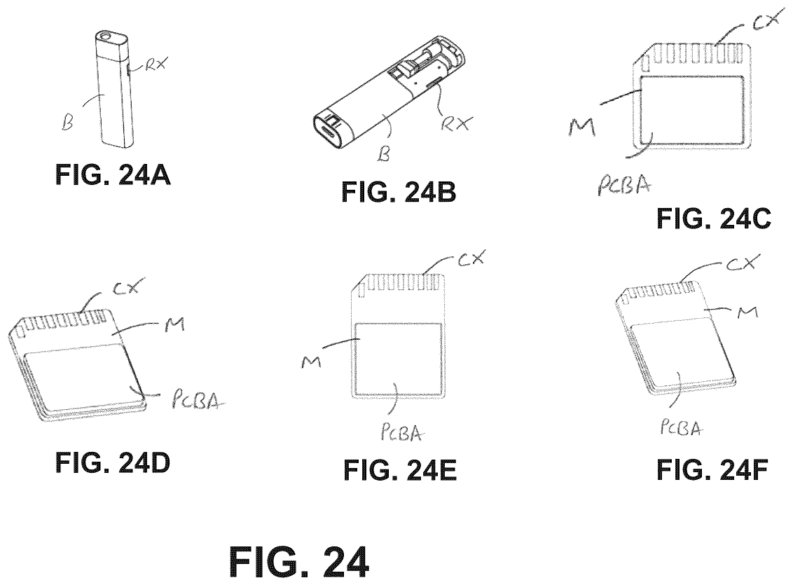

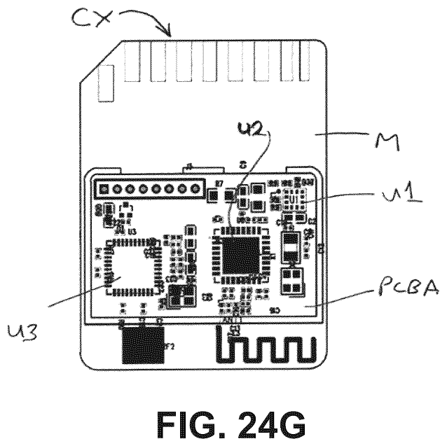

As shown in FIG. 5 (including FIGS. 24A-24G) the main function module M can be configured as an SD card or a mini or micro SD card or other circuit device that includes the printed circuit board assembly PCBA and that is received in a connector slot RX of the base B for operative connection of the printed circuit board assembly PCBA to the battery and/or other electronic circuitry of the base B through a module connector CX provided as part of the main function module M (see FIGS. 24A-24F).

FIG. 24G shows one example of the main function module M configured as an SD card, including the printed circuit board assembly PCBA that is configured to provide device locator functions as described above using as GPS, Bluetooth location, Ultra-wide band (UWB) internet of things IoT, and/or any suitable radio frequency location technology as implemented by circuits U1,U2, and/or U3, all of which are described below. As noted, the main function module M of FIG. 24G can be received in a connector slot RX of the base B to operably connect the printed circuit board assembly PCBA of the main function module M to a battery and/or other components and circuitry of the base B.

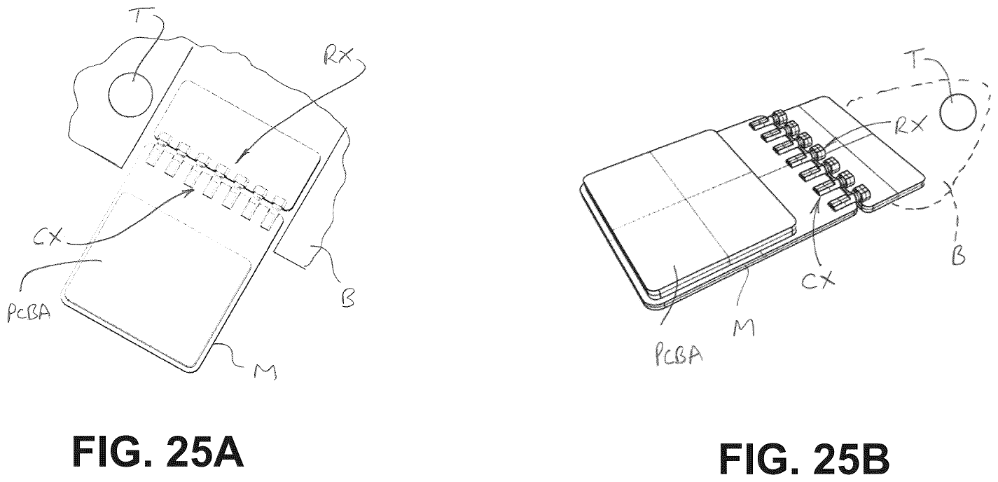

FIGS. 25A and 25B show an embodiments of the present development including a base B and a main function module M that can be selectively operably connected to the base B by a user and that can be selectively disconnected from the base B by the user without any special tools, i.e., the user can simply manually plug or otherwise manually connect the main function module M into the base and the user can also manually pull or otherwise disconnect the main function module M from the base B. In FIGS. 25A and 25B, the main function module is implemented on an SD card (standard size or reduced size such as a mini or micro SD card). In the illustrated example, the main function module M includes a printed circuit board assembly PCBA configured as a locator device but the printed circuit board assembly PCBA can alternatively be configured to perform an e-cigarette function or any other desired function. The main function module M can include a connector CX that be plugged into or otherwise operatively mated with a slot or other receiver electrical connector RX of the base B so that the printed circuit board assembly PCBA can be operatively electrically connected to the battery or other power source T and/or any other circuit or electronic device located in the base B mated connectors CX/RX. In this example, the base B includes a rechargeable battery T that can be recharged using a wired or wireless charger device. Alternatively, the battery T can be replaceable by a user. In this embodiment, the circuit board PCB is shown as a locator circuit board that can use any suitable wireless device location technology known in the art such as GPS, Bluetooth location, internet of things IoT, and/or any suitable radio frequency location technology.

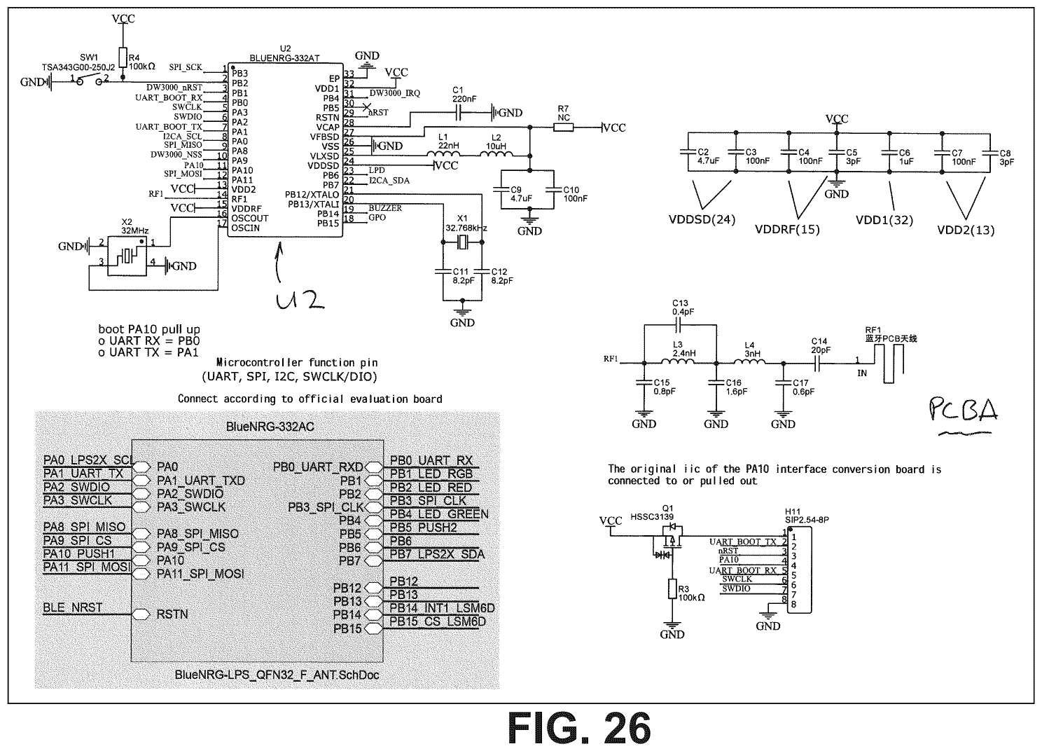

FIG. 26 shows that in one example, the printed circuit board assembly PCBA of the removable and replaceable main function module M can include an ultra-low power programmable Bluetooth Low Energy wireless System on Chip (SoC) device U2 or other Bluetooth circuitry that enables Bluetooth wireless device location and tracking and communication.

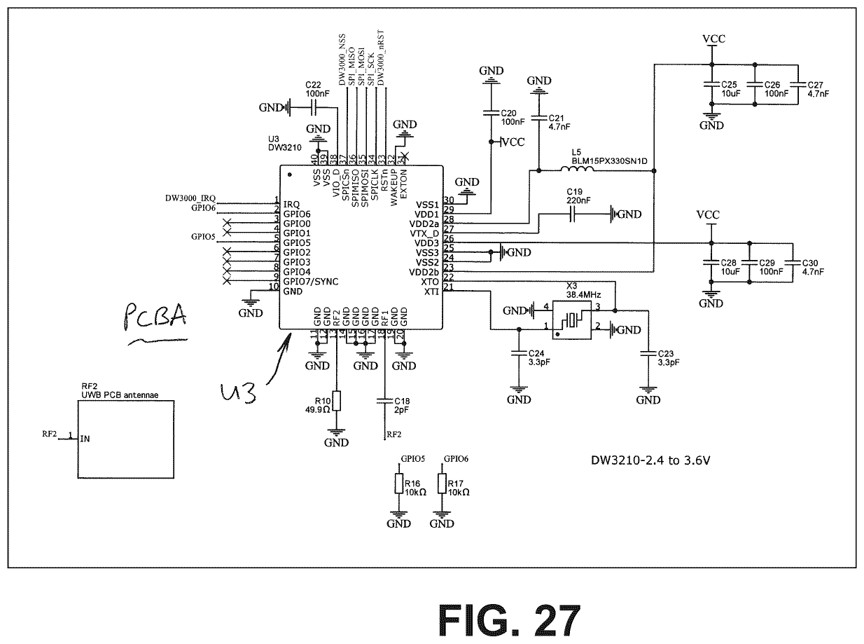

FIG. 27 shows that in an alternative example, the printed circuit board assembly PCBA of the removable and replaceable main function module M can include an Ultra-wide band (UWB) radio-frequency (RF) communication integrated circuit U3 or other UWB circuitry which enables UWB radio frequency wireless positioning location functions. The Ultra-wide band (UWB) circuitry U3 can be provided alone or together with the Bluetooth circuitry U2 disclosed above.

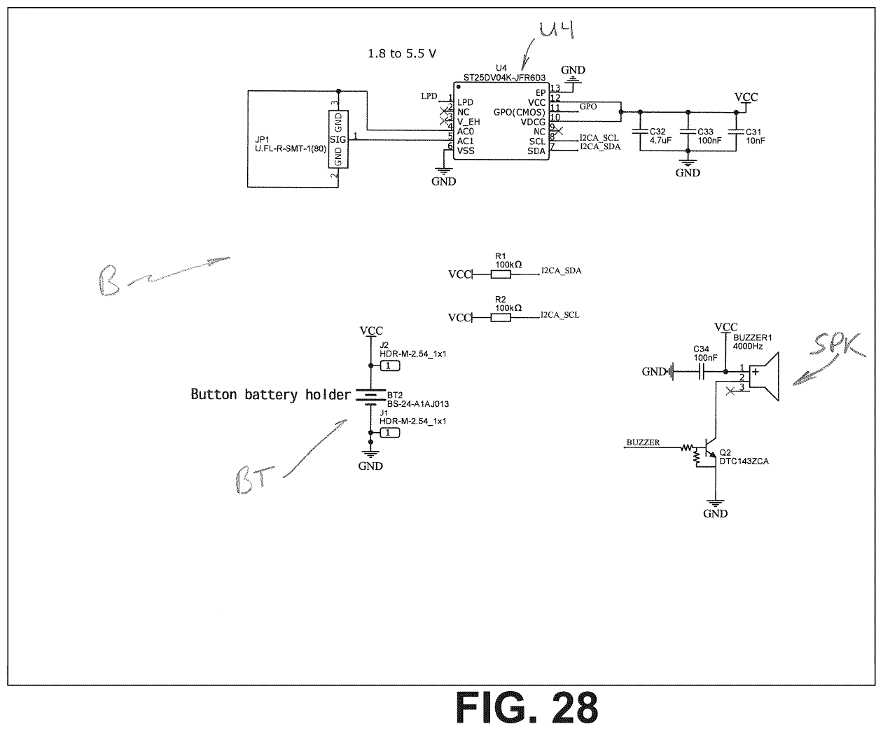

FIG. 28 shows that the base B can include a Near Field Communication (NFC) wireless RFID tag circuitry U4 for enabling wireless position locating functions and other functions such as access control, authentication, and the like. In one example, the NFC RFID circuitry is used for authentication, so that the luggage or other item to which the base B is connected can be verified as authentic when the NFC RFID circuitry outputs a required code/signal. FIG. 28 also discloses that the base B can include a battery BT and/or a speaker SPK for outputting sound. The base B can also include one or more LED lights or other light output device(s).

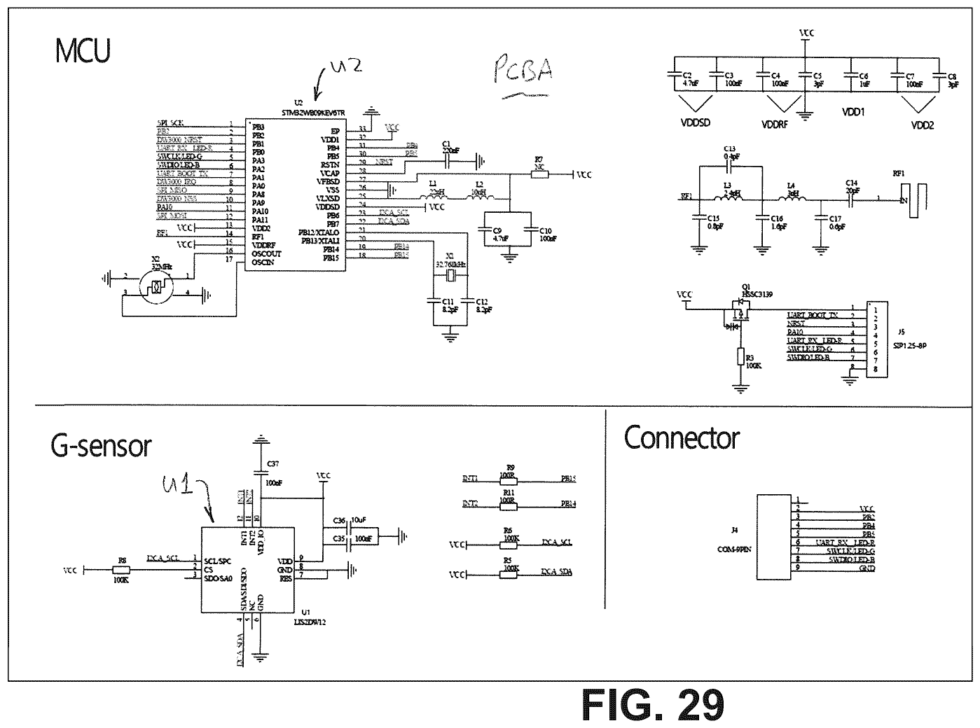

FIG. 29 shows that the printed circuit board assembly PCBA of the main function module M can comprise a Micro Controller Unit MCU including one or more of the locator circuits U2,U3,U4 and can also comprise additional circuitry and components such as a motion sensor or “G-sensor” device U1 that can be a MEMS 3-axis digital output motion sensor or another motion sensor or accelerometer and/or gyroscope sensor. The output of the motion sensor U1 can be used to determine and/or record motion or impacts of the device D and the item (luggage or other item) to which the device D is connected.

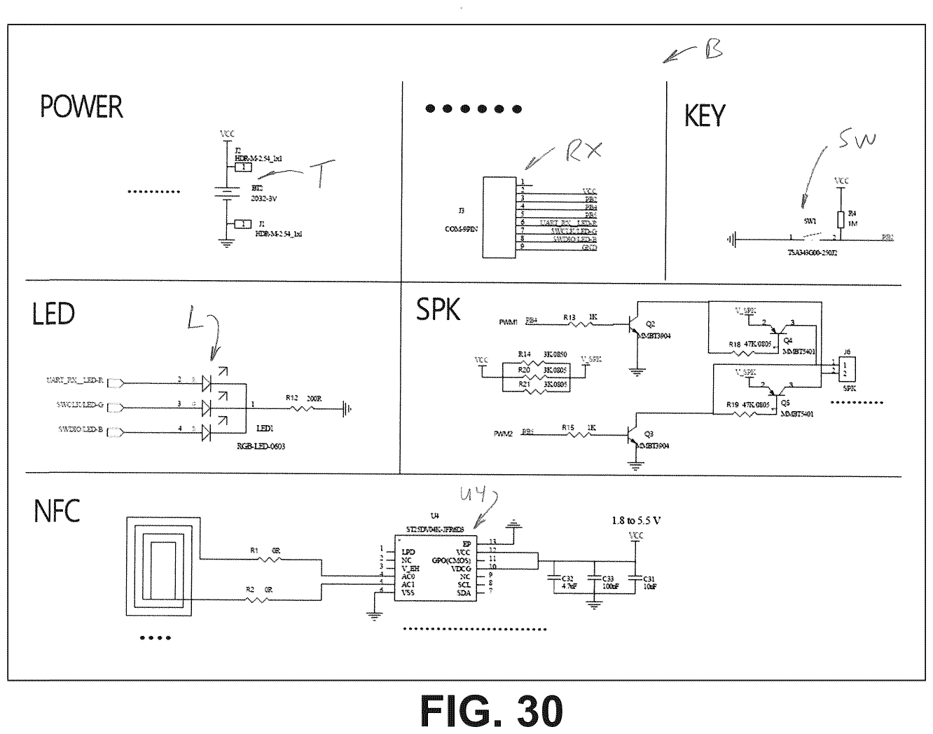

FIG. 30 shows that the base B (and/or the removable main function module M) can include a battery or other power source T, a connector RX, a push-button or other activation switch SW that can optionally be illuminated by an LED or other light source and that can selectively activate any component of the base B and/or the main function module, one or more LEDs L or other light outputting devices, a speaker SPK for outputting sound, and/or a Near Field Communication (NFC) tag or a 2-way NFC transceiver for communicating with a NFC reader in a cell phone or other device and/or for communicating with an NFC tag optionally provided as part of a removable module M to authenticate and/or activate (or deactivate) the module M.

The base B can also include a mounting tab or other location for receiving a fastener, stitching, a mounting ring, a post/stud, and/or any other suitable fastening device for operatively securing the base case B to a support structure such as a piece of luggage, another device, a person's clothing or portable device (e.g., mobile telephone or other device), a golf or other sports bag or equipment, and/or any other support structure.

The one or more LEDs L or other light source of the base B (or main function module M) can be continuously or selectively illuminated or partially illuminated under only certain conditions such as full battery charged, partial battery charge, low battery charge, or in response to a voice command, detection of a known or unknown mobile phone or other device, or any other condition. Likewise, the speaker SPK can emit a sound under certain conditions such as NFC operation, battery low, battery charged, connection with or disconnection from a main function module M, and/or during a “lost” condition when the device D has not been located for a certain amount of time.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

1. A circuit board for a locator device, the circuit board comprising:
a base;
a main printed circuit board assembly (PCBA) separate from the base.

2. The circuit board as set forth in claim 1, wherein the main PCBA is configured for updating when connected to the base.

3. The circuit board as set forth in claim 2, wherein the base comprises a battery charging circuit separate from the base.

4. The circuit board as set forth in claim 3, wherein the battery charging circuit and the main PCBA are configured for separate connection to the base.

5. The circuit board as set forth in claim 1, further comprising locator circuitry comprising one or more of radio frequency locator circuitry and near field communication circuitry.

6. The circuit board case as set forth in claim 1, including a housing including a recess with a primary connector located in the recess and operably connected with the main PCBA, wherein the based is selectively received in the recess of the housing and includes a secondary connector that operably mates with the primary connector when the base is operably installed in the recess.

7. The circuit board case as set forth in claim 6, further including a cover that connects to the housing and covers the recess and base located in the recess.

8. The circuit board as set forth in claim 7, further comprising a removable battery located in the recess.

9. The circuit board as set forth in claim 8, wherein the removable battery is located between the cover and the base.

10. The circuit board as set forth in claim 6, further including an external connector on the housing for transfer of at least one of electrical power and data into the housing.

11. The circuit board as set forth in claim 6, connected to a backpack or other luggage or clothing or other device.

12. The circuit board as set forth in claim 11, including a near field communication chip on the main PCBA inside the housing that provides near field communication capabilities.

13. A circuit board for a locator device, the circuit board comprising:
a base;
a main printed circuit board assembly (PCBA) separate from the base; and
a battery charging circuit separate from the base and main PCBA.

14. The circuit board as set forth in claim 13, wherein the battery charging circuit and the main PCBA are configured for separate connection to the base.

15. The circuit board as set forth in claim 14, wherein the main PCBA is configured for updating when connected to the base.

16. The circuit board as set forth in claim 13, further comprising locator circuitry comprising one or more of radio frequency locator circuitry and near field communication circuitry.

17. A piece of luggage, comprising
a circuit board for a locator device, the circuit board comprising:
a base;
a main printed circuit board assembly (PCBA) separate from the base; and
a battery charging circuit separate from the base and main PCBA.

18. The piece of luggage as set forth in claim 17, wherein the battery charging circuit and the main PCBA are configured for separate connection to the base.

19. The piece of luggage as set forth in claim 18, wherein the main PCBA is configured for updating when connected to the base.

20. The piece of luggage as set forth in claim 17, further comprising locator circuitry comprising one or more of radio frequency locator circuitry and near field communication circuitry.
